(19) United States
(12) Patent Application Publication
(10) Pub. No.: US 2016/0314506 A1
(43) Pub. Date: Oct. 27, 2016

(54) METHOD, DEVICE, COMPUTER PROGRAM AND COMPUTER READABLE RECORDING MEDIUM FOR DETERMINING OPINION SPAM BASED ON FRAME

(71) Applicant: KOREA UNIVERSITY RESEARCH AND BUSINESS FOUNDATION, Seoul (KR)

(72) Inventors: Jaewoo Kang, Seoul (KR); Seongsoon Kim, Seoul (KR); Hyeokyoon Chang, Seoul (KR); Sung-Woon Lee, Seoul (KR)

(21) Appl. No.: 15/135,209

(22) Filed: Apr. 21, 2016

(30) Foreign Application Priority Data
Apr. 23, 2015 (KR) 10-2015-0057507

(51) Int. Cl. G06Q 30/02; G06F 17/27; G06N 99/00

(52) U.S. Cl. CPC G06Q 30/0282; G06N 99/005; G06F 17/2705

(57) ABSTRACT

A frame-based opinion spam determination method is provided. The method is performed by a processor of a frame-based opinion spam determination device. The method may include (a) receiving an input text; and (b) determining whether or not the input text is opinion spam using a machine learning-based opinion spam determination model considering a frame extracted from multiple opinion spam samples as an opinion spam determination element, wherein the frame is a semantic unit of included in an event expressed in a sentence.

### CROSS-REFERENCE TO RELATED APPLICATION

This application claims the benefit under 35 USC 119(a) of Korean Patent Application No. 10-2015-0057507 filed on Apr. 23, 2015, in the Korean Intellectual Property Office, the entire disclosures of which are incorporated herein by reference for all purposes.

### TECHNICAL FIELD

The present disclosure relates to a method, a device, a computer program, and a computer readable recording medium for determining opinion spam based on a frame. More particularly, the present disclosure relates to a method, a device, a computer program, and a computer readable recording medium for determining opinion spam based on a frame by analyzing a semantic relationship included in a review text and determining whether the review is an opinion spam.

### BACKGROUND

Recently, due to the development of social media, numerous users' opinions (or reviews) about various topics are being shared and spread online. Further, a number of users trust online reviews and consider the reviews when making an actual purchase. Therefore, opinions about a specific product or service provided online affect decision making in real life.

Meanwhile, there has been a gradual increase in the misuse of online users' opinions for business purpose. By way of example, one may ask a third person who has not used his/her company to leave positive opinions for marketing his/her company or to leave malicious opinions about a rival company. A number of such cases have been reported.

As such, an opinion written with intent regardless of experience of using a service or a product is called opinion spam. Recently, such opinion spam has been written too skillfully to be recognized by general people and has hindered the online distribution of sound information.

Accordingly, in recent years, there have been attempts to conduct studies to distinguish opinion spam using mechanical algorithms. The studies have been developed in roughly three categories: review unit analysis; review writer unit analysis; and spammer group analysis. Particularly, representative studies involved in review unit analysis may include Ott, M., Choi, Y., Cardie, C., Hancock, J, T.: Finding deceptive opinion spam by any stretch of the imagination. In Proc. HLT'11. pp. 309-319 (2011) (hereinafter, referred to as “Document 1”) and Li, J., Ott, M., Cardie, C., Hovy, E.: Towards a General Rule for Identifying Deceptive Opinion Spam. In Proc. ACL'14. pp. 1566-1576 (2014) (hereinafter, referred to as “Document 2”).

Document 1 suggests a model for determining opinion spam by ordering people who have not experienced a specific hotel to leave positive opinions about the hotel, collecting opinion spam data, and determining opinion spam with simple elements, such as n-grams or parts-of-speech, using the opinion spam data. Document 2 points out that the model suggested in Document 1 is limited in targeting only opinion spam of review writers who have not have use experience in business and suggests a model for determining opinion spam on the basis of opinion spam data directly written by those who have expert knowledge and experience in the corresponding business.

However, conventional techniques have been based on meta data of opinion spam writers in determining opinion spam, or restricted to shallow syntactic analysis of differences in using parts-of-speech or words between real reviews and opinion spam. Therefore, a one-step deeper analysis of a semantic relationship between words included in opinion spam has not been conducted.

### SUMMARY

The present disclosure concerns an opinion spam determination model of analyzing a semantic relationship in a sentence and determining opinion spam based on a frame which is a semantic unit included in an event expressed in the sentence.

However, problems to be solved by the present disclosure are not limited to the above-described problems. There may be other problems to be solved by the present disclosure.

A frame-based opinion spam determination method is provided herein. The method may be performed by a processor of a frame-based opinion spam determination device. The method may include (a) receiving an input text; and (b) determining whether or not the input text is opinion spam using a machine learning-based opinion spam determination model considering a frame extracted from multiple opinion spam samples as an opinion spam determination element, wherein the frame is a semantic unit of included in an event expressed in a sentence.

A frame-based opinion spam determination device is provided herein. The device may include a memory configured to store a program for determining whether or not an input text is opinion spam using a frame which is a semantic unit of included in an event expressed in a sentence; and a processor configured to execute the program, wherein the process may receive the input text and determine whether or not the input text is opinion spam considering a frame extracted from multiple opinion spam samples as an opinion spam determination element upon execution of the program.

The above-described exemplary methods and systems are provided by way of illustration only and should not be construed as liming the present disclosure. Besides the above-described exemplary methods and systems, there may be additional exemplary methods and systems described in the accompanying drawings and the detailed description.

In some scenarios, an opinion spam model is constructed using a ‘frame’ which is a semantic unit included in an event expressed in a sentence and opinion spam is distinguished using the opinion spam model. Therefore, a semantic relationship between words in the sentence can be found unlike the conventional techniques focusing on shallow syntactic analysis of differences in using parts-of-speech or words. Further, opinion spam is distinguished using the found semantic relationship. Therefore, the opinion spam determination accuracy can be further improved as compared with a conventional machine learning-based classification model.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 and FIG. 2 are conceptual diagrams structurally illustrating relationships between a sentence and a frame.

FIG. 3 is a block diagram provided to explain a structure of a frame-based opinion spam determination device.

FIG. 4 is a graph showing ΔNFF indexes of some frames extracted on the basis of an opinion spam sample written by a non-expert group and a real opinion.

FIG. 5 is a graph showing ΔNFF indexes of some frames extracted on the basis of an opinion spam sample written by an expert group and a real opinion.

FIG. 6 is a table showing ΔNF_{BO}F values of some frame pairs extracted on the basis of an opinion spam sample written by a non-expert group and a real opinion.

FIG. 7 is a table showing ΔNF_{BO}F values of some frame pairs extracted on the basis of an opinion spam sample written by an expert group and a real opinion.

FIG. 8 provides graphs showing the opinion spam determination accuracy of a machine learning-based classification model according to a frame number.

FIG. 9 is a flowchart about a frame-based opinion spam determination method.

FIG. 10 is a table comparing the performance between a conventional machine learning-based classification model and a case where a frame is applied as an opinion spam determination element to corresponding classification model.

FIG. 11 is a table showing the performance of a case where a frame and a frame binary order are applied as opinion spam determination elements to a conventional classification model.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, it is to be understood that the term “comprises or includes” and/or “comprising or including” used in the document means that one or more other components, steps, operation and/or existence or addition of elements are not excluded in addition to the described components, steps, operation and/or elements unless context dictates otherwise and is not intended to preclude the possibility that one or more other features, numbers, steps, operations, components, parts, or combinations thereof may exist or may be added.

Through the whole document, the term “unit” includes a unit implemented by hardware, a unit implemented by software, and a unit implemented by both of them. One unit may be implemented by two or more pieces of hardware, and two or more units may be implemented by one piece of hardware. However, “the unit” is not limited to the software or the hardware, and “the unit” may be stored in an addressable storage medium or may be configured to implement one or more processors. Accordingly, “the unit” may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and functions provided by “the units” can be combined with each other or can be divided up into additional components and “the units”. Further, the components and “the units” may be configured to implement one or more CPUs in a device or a secure multimedia card.

Hereinafter, the terms used herein will be defined.

The term “opinion spam” means an opinion or review written with a certain intent regardless of experience about a service or a product.

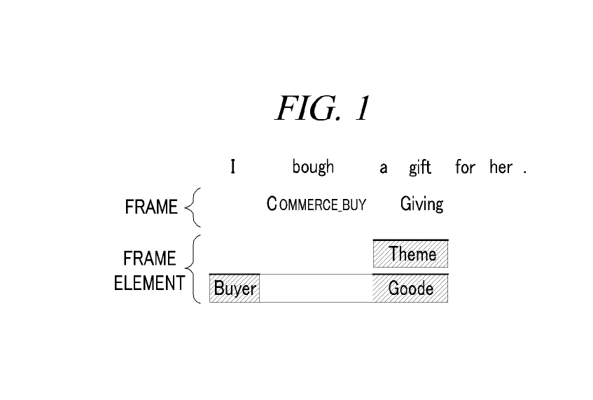

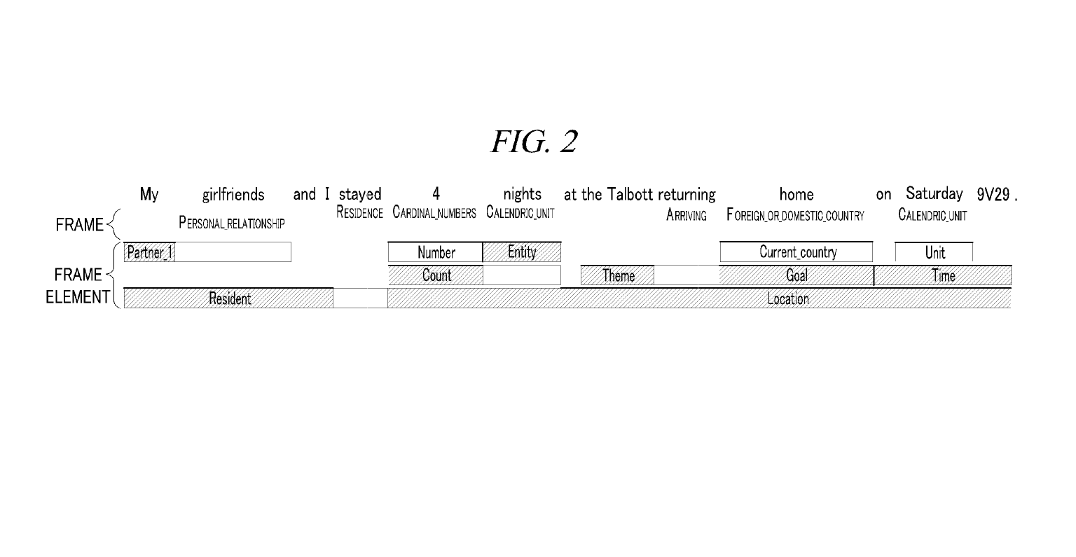

The term “frame” means information for a semantic unit included in an event expressed in a sentence. The term “frame” was introduced in the Frame Semantics theory developed by Charles J. Fillmore. For example, referring to FIG. 1, the verb “bought” from the sentence “I bought for a gift for her.” is a main verb that triggers the frame “COMMERCE_BUY (purchase information)”. In this case, the subject “I” and the object “gift” respectively correspond to “Buyer” and “Goods” which are critical semantic elements constituting the frame “COMMERCE_BUY (purchase information)”. As another example, referring to FIG. 2, the sentence “My girlfriends and I stayed 4 nights at the Talbott returning home on Saturday” include a total of 7 frames (PERSONAL_RELATIONSHIP (information about human relationships with narrator), RESIDENCE (residence behavior information), CARDINAL_NUMBERS (information about number, cardinal, and number of times), CALENDRIC_UNIT (information about date, day, and duration), ARRIVING (arrival behavior information), FOREIGN_OR_DOMESTIC_COUNTRY (country information), CALENDRIC_UNIT (information about date, day, and duration)). According to the semantic analysis of the frames, it can be seen that the sentence implies that a person in a specific relationship with a writer arrives and resides in a domestic or foreign country for a specific duration. As such, it is possible to analyze semantic units of a sentence or relationships among the semantic units by extracting frames from the sentence.

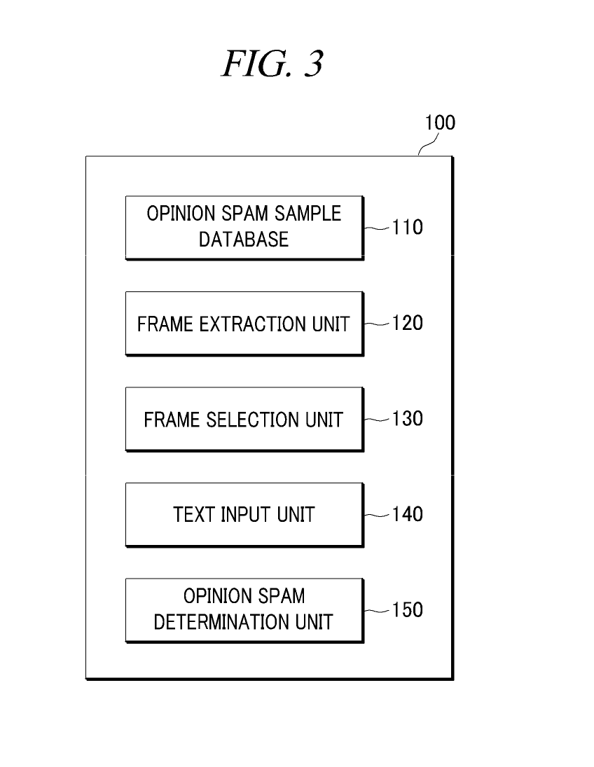

FIG. 3 is a block diagram provided to explain a structure of a frame-based opinion spam determination device 100.

The opinion spam determination device 100 includes a memory (not illustrated) and a processor (not illustrated). The memory is configured to store a program for determining opinion spam using a frame, and the processor is configured to control the stored program to determine whether or not an input text is opinion spam upon execution of the program. Herein, the processor may include subcomponents such as an opinion spam sample database 110, a frame extraction unit 120, a frame selection unit 130, a text input unit 140, and an opinion spam determination unit 150. In some cases, the opinion spam sample database 110 through the frame selection unit 130 may be selectively included in the processor.

The opinion spam sample database 110 is configured to store multiple opinion spam samples. An opinion spam sample is an example of opinion sample and refers to a negative opinion or positive opinion written by a random writer with intent about a specific object (i.e., service or product). Each opinion spam sample may be formed of at least one sentence. Herein, the random writer may be a non-expert or an expert about the specific object. Further, the opinion spam samples may be opinion spam about one object or may be opinion spam about two or more objects. Meanwhile, the opinion spam sample database 110 may not be provided within the opinion spam determination device 100, but may be provided outside the opinion spam determination device 100 as being communication connected to the opinion spam determination device 100.

The frame extraction unit 120 is configured to extract at least one frame from the multiple opinion spam samples in the opinion spam sample database 110. To be specific, the frame extraction unit 120 divides each opinion spam sample into at least one sentence. In most cases, an opinion spam sample is not written as being divided into sentences and thus needs to be divided into sentences. Herein, the opinion spam sample can be divided into at least one sentence by a sentence divider. Then, the frame extraction unit 120 may analyze relationships among words included in each divided sentence. To be specific, the frame extraction unit 120 may conduct an analysis as to parts-of-speech (e.g., subject, object, and the like) of the words included in each sentence and arrangement relationships among the words.

Further, the frame extraction unit 120 may find a main word that triggers a specific frame from the sentences with reference to a frame dictionary database (not illustrated) and find a context around the main word. Then, the frame extraction unit 120 may extract a frame corresponding to the main word and the context on the basis of a probability model. The frame dictionary database is a database in which relationships between words and frames are defined according to the context. The frame dictionary database is a database constructed from a dictionary where relationships of an event present in a sentence or between objects constituting the event are standardized into frames on the basis of the Frame Semantics theory developed by Charles J. Fillmore. Referring to the frame dictionary database, it is possible to find out which word of words constituting a sentence triggers a frame according to the context and also possible to find out a critical semantic element of the frame. That is, the same word included in two different sentences may trigger different frames depending on the context of a sentence. Further, a frame which can be extracted from each sentence according to the context may be defined on the basis of a probability model. By way of example, assuming “there is a 90% or higher probability that a frame a′ and a frame a″ will be extracted from a sentence A having a specific structure and specific words”, if a specific sentence is identical or similar to the sentence A, the frame a′ and the frame a″ may be extracted as frames of the specific sentence. The frame dictionary database may be included in the opinion spam determination device 100, or may be provided outside the opinion spam determination device 100 as being communication connected to the opinion spam determination device 100.

To be specific, referring to an example as shown in FIG. 2, a total of 7 frames may be extracted from a sentence. That is, the subject “girlfriends” may be matched with the frame “PERSONAL_RELATIONSHIP (information about human relationships with narrator)”, the verb “stayed” may be matched with the frame “RESIDENCE (residence behavior information)”, the number “4” may be may be matched with the frame “CARDINAL_NUMBERS (information about number, cardinal, and number of times)”, the object “nights” may be matched with the frame “CALENDRIC_UNIT (information about date, day, and duration)”, the verb “returning” may be matched with the frame “ARRIVING (arrival behavior information)”, the noun “home” may be matched with the frame “FOREIGN_OR_DOMESTIC_COUNTRY (country information)”, and the date “Saturday” may be matched with the frame “CALENDRIC_UNIT (information about date, day, and duration)”. Further, an influence range of each frame is indicated by hatching. By way of example, the frame “PERSONAL_RELATIONSHIP (information about human relationships with narrator)” may influence “My”, “girlfriend”, “and”, and “I”, and both “My girlfriend” and “I” have the meanings corresponding to “Resident”. As such, if frames are extracted from a sentence, semantic relationships in the sentence can be found using the frames.

The frame selection unit 130 is configured to quantify the frequency of the frames extracted by the frame extraction unit 120 in the multiple opinion spam samples and select a certain number of frames. In this case, it is possible to quantity the frequency of the frames using at least one of indexes NFF (Normalized Frame Frequency) and NF_{BO}F (Normalized Frame Binary Ordering Frequency). Herein, the NFF is an indicator of how often a specific frame occurs in the multiple opinion spam samples, and the NF_{BO}F is a ratio of occurrence of a specific frame pair to all frame pairs in the multiple opinion spam samples. Particularly, the NF_{BO}F is an indicator showing the order of occurrence of frames. Therefore, such an index makes it possible to assess the intention of the narrator.

Further, if data about multiple real opinions written by users who actually use a specific object are separately included in the opinion spam sample database 110, the frame extraction unit 120 may extract frames from the multiple real opinions and the frame selection unit 130 may quantify the frequency in the multiple real opinions and select a certain number of frames. Furthermore, the frame selection unit 130 may select all of frames extracted from the multiple real opinions and frames extracted from the multiple opinion spam samples.

It is difficult to construct an opinion spam determination model considering all frames extracted from opinion spam samples or real opinions as opinion spam determination elements. Therefore, the frame selection unit 130 may select only a certain number of frames in order of higher value of at least one of the NFF and the NF_{BO}F. High NFF and NF_{BO}F of a frame means a high probability that the corresponding frame or frame pair will frequently occur in opinion spams or real opinions.

Otherwise, a frame may be selected using a value of ΔNFF (NFF _{opinion spam sample—}NFF_{real opinion}) or ΔNF_{BO}F (NF_{BO}F_{opinion spam sample—}NF_{BO}F_{real opinion}). To be specific, the ΔNFF and the ΔNF_{BO}F may be defined by the following Equation 1 and Equation 2, respectively:

ΔNFF_{f}_{ₘ}=NFF_{D}_{_{deceptive}}fₘ−NFF_{D}_{ₜᵣᵤₜₕ}fₘ (1)
Dataset D, Frame f, Class C={truth,deceptive}
Set F₁={∀f in Dᵢ},i∈C
Frame Frequency f_{q}=frame occurrence in Dᵢ where f_{q}∈F, i∈C
NFF_{D}_{ⱼ}fₘ=f_{q}/Σₖ₌₁^{|f}^{ⱼ}^{|}fₖ,j∈C

ΔNF_{BO}F_{f}_{ⱼₖ}=NF_{BO}F_{d}_{_{deceptive}}fⱼₖ−NFF_{D}_{ₜᵣᵤₜₕ}fⱼₖ (2)
Dataset D, Frame f, Class C={truth,deceptive}
Set Fᵢ={∀f in Dᵢ},i∈C
Frame binary ordering frequency for frame fⱼ and fₖ, fboⱼₖ=number of frame pair occurrence fⱼ and fₖ in which fⱼ occured followed by fₖ in a sentence sₜ where {fⱼ, fₖ}∈Fᵢ, sₜ∈Dᵢ, i∈F
NF_{BO}F_{D}_{ⱼ} for fₗ and fₘ=fboₗₘ/Σ_{l-1, m-1}^{|F}^{ⱼ}^{|}fₗₘ,j∈C

Herein, high ΔNFF or ΔNF_{BO}F means that the corresponding frame or frame pair frequently occurs in opinion spam, and low ΔNFF or ΔNF_{BO}F means that the corresponding frame or frame pair frequently occurs in real opinions. That is, a frame with a high absolute value of ΔNFF or ΔNF_{BO}F may represent a characteristic mainly occurring in opinion spam or real opinions. Therefore, the frame selection unit 130 may select a frame with a high absolute value of ΔNFF or ΔNF_{BO}F in order to apply all the characteristics of opinion spam and real opinions as learning attributes to a machine learning-based classification model to be described later.

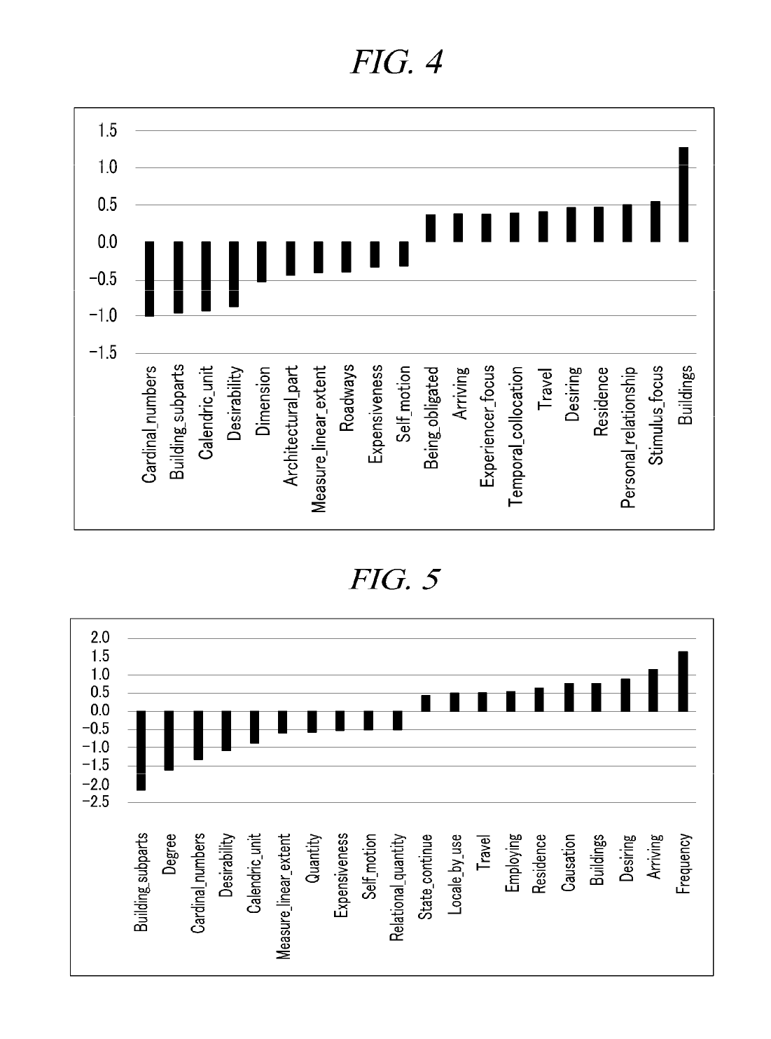

FIG. 4 is a graph showing ΔNFF indexes of some frames extracted on the basis of an opinion spam sample written by a non-expert group and a real opinion, and FIG. 5 is a graph showing ΔNFF indexes of some frames extracted on the basis of an opinion spam sample written by an expert group and a real opinion. Referring to FIG. 4 and FIG. 5, it can be seen that the frame “Cardinal_numbers (information about number, cardinal, and number of times)” and the frame “Building_subparts (detailed information of building)” more frequently occur in the real opinions, and the frame “Buildings (building information)” and the frame “Travel (travel information)” more frequently occur in the opinion spam samples. By way of example, opinion spam samples relate to personal experience of the writers and thus tend to lack detailed description of a place. For this reason, the opinion spam samples mainly include frames, such as “travel” and “building”, having a superficial meaning. Further, it can be seen that the opinion spam samples mainly include frames (Personal_relationship), such as “spouse” or “family”, in order for readers to further trust opinion spam. On the other hand, real opinions are written on the basis of experience of writers. It can be seen that the real opinions mainly include frames, such as “specific date”, “interior of building”, “price or size or dimension”, relating to specific and detailed contents.

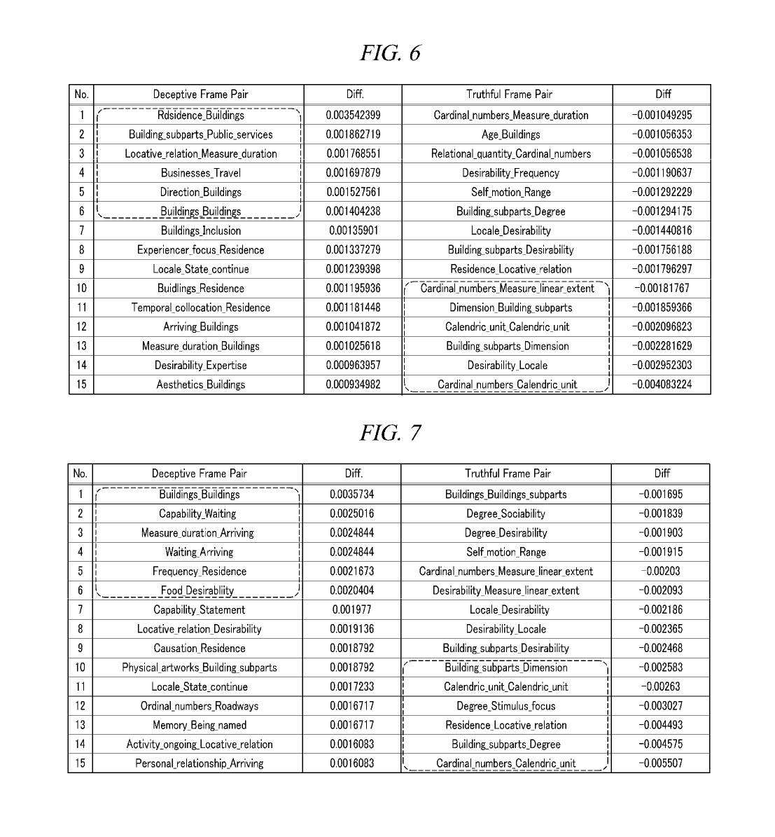

FIG. 6 is a table showing ΔNF_{BO}F values of some frame pairs extracted on the basis of an opinion spam sample written by a non-expert group and a real opinion, and FIG. 7 is a table showing ΔNF_{BO}F values of some frame pairs extracted on the basis of an opinion spam sample written by an expert group and a real opinion. Referring to FIG. 6 and FIG. 7, the measured ΔNF_{BO}F values of the frame pairs “Cardinal_numbers (information about number, cardinal, and number of times)−Calendric_unit (information about date, day, and duration)” and “Building_subparts (detailed information of building)−Degree (status information)” are low. Accordingly, it can be seen that real numbers or specific days or dates or details such as a detailed size of a building are frequently mentioned in the real opinions. On the other hand, the frame pair “Measure_duration (duration information)−Arriving (arrival behavior information)” is used to describe “arrived . . . with consumption of a long time” and the measured ΔNF_{BO}F value is high. Accordingly, it can be seen that characterless and less detailed terms are mainly mentioned in opinion spam. Further, it can be seen from the low ΔNF_{BO}F value of the frame pair “Cardinal_numbers (information about number, cardinal, and number of times)−Calendric_unit (information about date, day, and duration)” that a specific date cannot be made up even in an opinion spam sample written by an expert group.

Referring to FIG. 3 again, the text input unit 140 is configured to receive a text input into the opinion spam determination device 100 by a user. The input text refers to a text including opinions of users, and may include at least one sentence written by at least one user.

The opinion spam determination unit 150 may insert the frames selected by the frame selection unit 130 into the machine learning-based classification model as opinion spam determination elements to construct an opinion spam determination model, and determine whether or not the input text is opinion spam using the opinion spam determination model. In this case, if the frame selection unit 130 selects some frames with a high absolute value of ΔNFF or ΔNF_{BO}F, a frame (hereinafter, referred to as “first frame”) representing a characteristic of opinion spam samples and a frame (hereinafter, referred to as “second frame”) representing a characteristic of real opinions may be inserted as opinion spam determination elements. Accordingly, the opinion spam determination unit 150 may construct an opinion spam determination model that learns both the characteristics occurring in the opinion spam samples and the real opinions using the first frame and the second frame. The opinion spam determination model constructed as such may determine an input text including a frame identical to the first frame as opinion spam, and the opinion spam determination model may determine an input text including a frame identical to the second frame as not opinion spam.

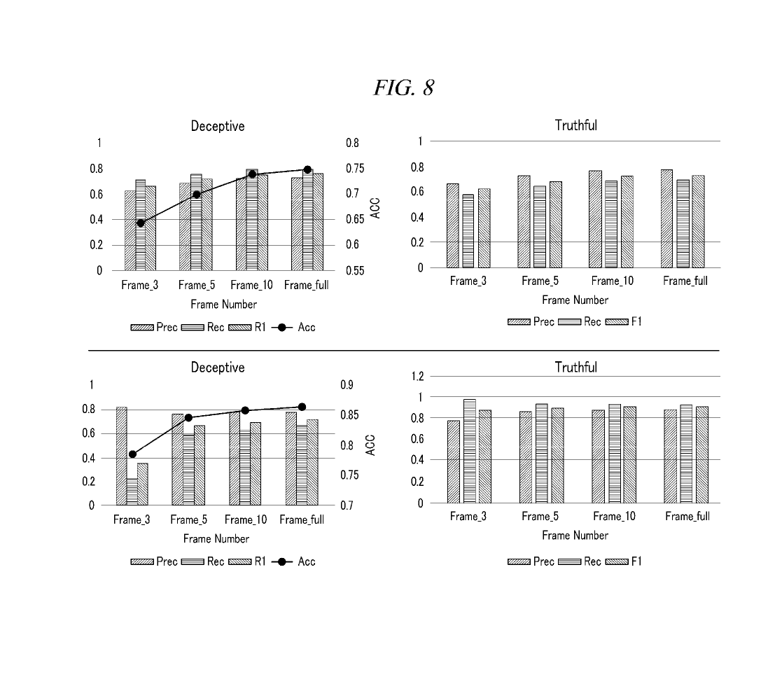

Meanwhile, the number of frames inserted as opinion spam determination elements is not limited. However, as the number of frames is increased, the opinion spam determination accuracy may be improved. FIG. 8 provides graphs showing the opinion spam determination accuracy of a machine learning-based classification model according to a frame number. The graph on the left top side of FIG. 8 shows an example about opinion spam samples of a non-expert group and also shows that the measured opinion spam determination accuracy of Frame_3 is 0.63. Accordingly, it can be seen that even if only a total of 6 frames (frames corresponding to the highest 3 absolute values from each of both ends (+, −) of the NFF distribution) are used as opinion spam determination elements, a probability of 63% higher than a randomly selected probability (50%) is obtained. Further, the graph on the left bottom side of FIG. 8 shows an example about opinion spam samples of an expert group. It can be seen that even if the number of frames used as opinion spam determination elements is reduced from 10 to 3, the opinion spam determination accuracy is not decreased to 0.8 or less. That is, it can be seen that the frames selected using the index NFF can be used as very effective attributes in determining opinion spam.

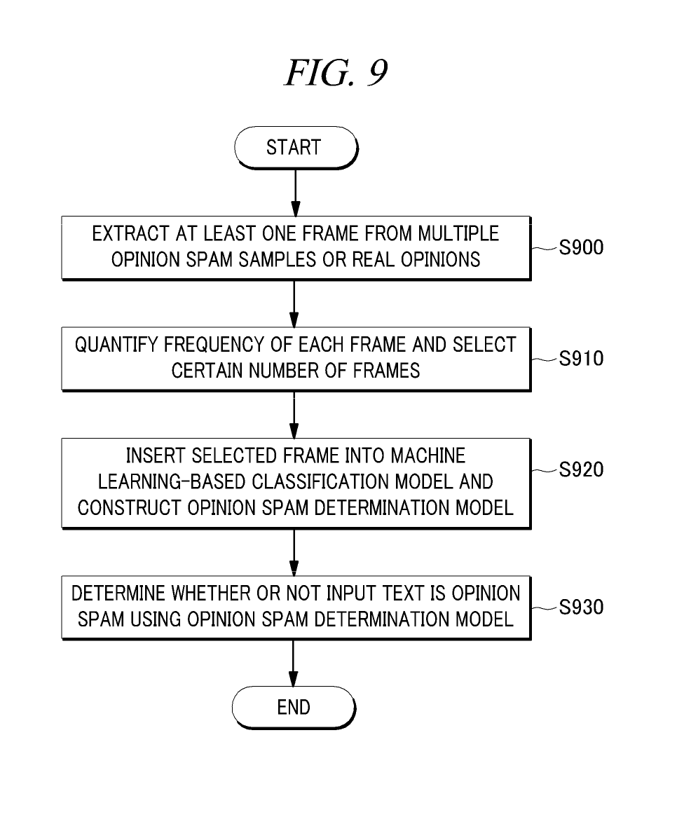

Hereinafter, referring to FIG. 9, an opinion spam determination method will be described in detail. FIG. 9 is a flowchart about a frame-based opinion spam determination method. The opinion spam determination method to be described below is performed by the above-described opinion spam determination device 100. Although omitted in the following description, the description already made for the opinion spam determination device 100 may apply to the opinion spam determination method.

The opinion spam determination device 100 may extract at least one frame from multiple opinion spam samples or real opinions (S900). To be specific, each opinion spam sample may not be written as being divided into sentences. Thus, each opinion spam sample is divided into at least one sentence by a sentence divider. Then, relationships among words included in each sentence are analyzed. Then, a main word that triggers a specific frame is found from one sentence with reference to the frame dictionary database, and a context around the main word is found. Then, a frame corresponding to the main word and the context is extracted on the basis of a probability model. As such, at least one frame can be extracted from each opinion spam sample. Likewise, at least one frame can be extracted from a real opinion.

Then, the frequency of each frame in the multiple opinion spam samples and the real opinions may be quantified, and a certain number of frames may be selected from the extracted frames (S910). It takes too much capacity and load to consider all the extracted frames as opinion spam determination elements. Therefore, the frequency of each frame in the opinion spam sample database 110 may be quantified in order to select a certain number of frames. As a means for quantification, at least one of indexes NFF and NF_{BO}F may be used. Herein, a certain number of frames with high absolute values of ΔNFF and ΔNF_{BO}F may be selected.

Then, the selected frames may be inserted into a machine learning-based classification model as opinion spam determination elements to construct an opinion spam determination model (S920).

Finally, if there is an input text, the input text may be input into the opinion spam determination model to determine whether or not the input text is opinion spam (S930).

In the above description, S900 to S930 may be further divided up into additional steps or may be combined with each other. Further, some steps may be omitted if necessary, or the order thereof may be changed.

As described above, if a frame is inserted into a conventional machine learning-based classification model as an opinion spam determination element, semantic relationships of sentences included in an input text to determine whether or not the input text is opinion spam. Therefore, the opinion spam determination accuracy can be further improved as compared with the conventional machine learning-based classification model.

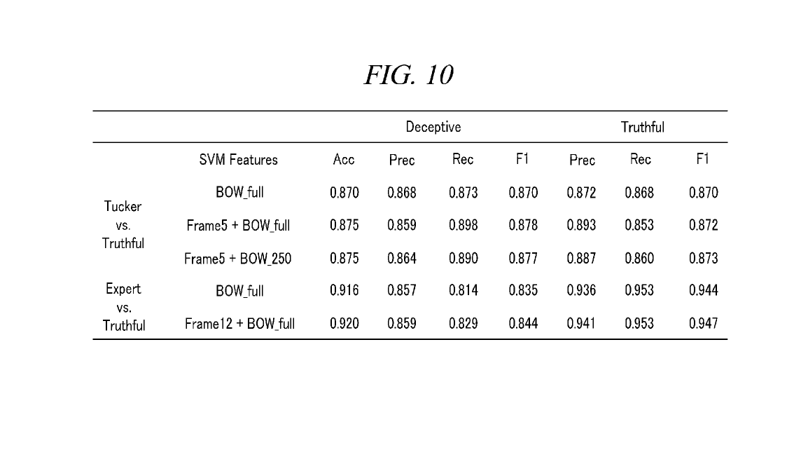

FIG. 10 is a table comparing the performance between a conventional machine learning-based classification model and a case where a frame is applied as an opinion spam determination element to corresponding classification model. Referring to FIG. 10, the machine learning-based classification model uses a SVM model, and Tucker vs. Truthful shows a SVM model test result based on opinion spam samples written by a non-expert group and Expert vs. Truthful shows a SVM model test result based on opinion spam samples written by an expert group. As for the opinion spam determination accuracy (Acc) among the SVM Features, BOW_full shows a case where opinion spam is distinguished using only BOW (Bag-of-Word) as the existing attribute of the SVM model and the calculated values of BOW_full are 0.870 and 0.916. However, Frame5+BOW_full, Frame5+BOW_250, and Frame12+BOW_full show cases where a frame is added as an opinion spam determination element and the calculated values of Frame5+BOW_full, Frame5+BOW_250, and Frame12+BOW_full are 0.875 and 0.920 which are higher than 0.870 and 0.916, respectively.

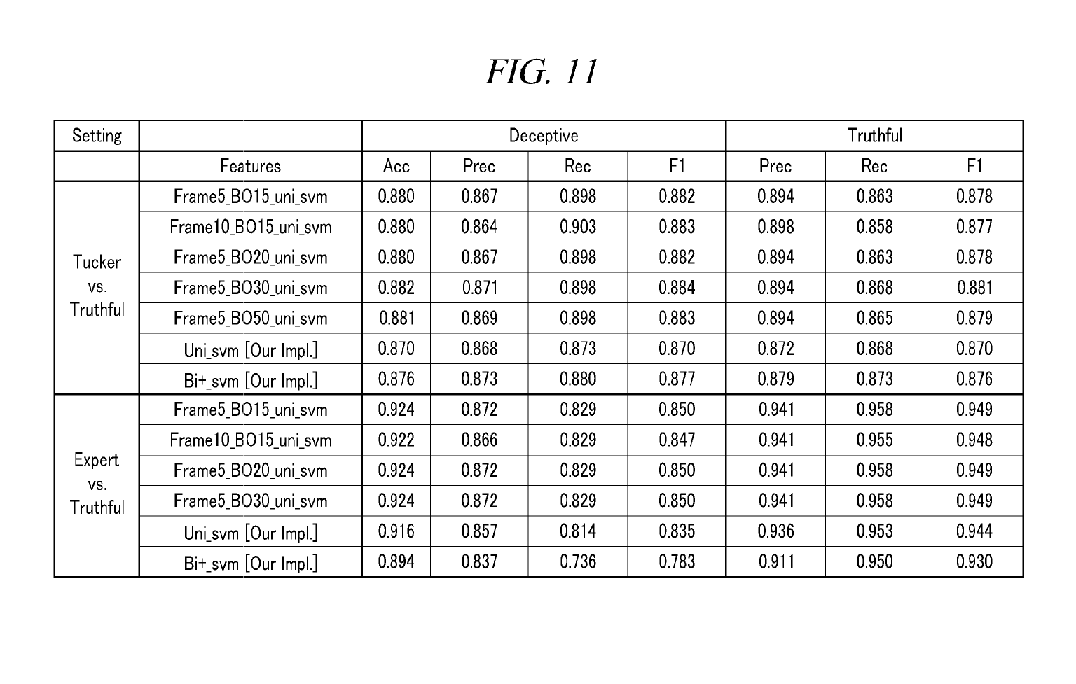

FIG. 11 is a table showing the performance of a case where a frame and a frame binary order are applied as opinion spam determination elements to a conventional classification model. Herein, the term “Frame5_BO30” shows a case where frames corresponding to the highest 5 absolute values from each of both ends (+, −) of the ΔNFF distribution and frames corresponding to the highest 30 absolute values from each of both ends (+, −) of the ΔNF_{BO}F distribution are applied as opinion spam determination elements. According to the SVM model test result based on the opinion spam samples written by the non-expert group, if only a frame is considered as an opinion spam determination element, the accuracy has a value of 0.870 as shown in FIG. 10. If a frame binary order is also considered as an opinion spam determination element, the accuracy has a higher value of 0.882 as shown in FIG. 11. Further, according to the other test result, it can be seen that the accuracy of the case as shown in FIG. 11 is higher than the accuracy of the case as shown in FIG. 10. Therefore, if both the frame binary order and the frame are considered as opinion spam determination elements, it is possible to determine opinion spam with higher accuracy.

According to the above-described exemplary methods and systems, an opinion spam determination model is constructed using a frame which is a semantic unit included in an event expressed in a sentence and opinion spam is distinguished using the opinion spam determination model. Therefore, a semantic relationship between words in the sentence can be found unlike the conventional techniques focusing on shallow syntactic analysis of differences in using parts-of-speech or words. Further, opinion spam is distinguished using the found semantic relationship. Therefore, the opinion spam determination accuracy can be further improved as compared with the conventional machine learning-based classification model.

The present disclosure can be implemented in a storage medium including instruction codes executable by a computer or processor such as a program module executed by the computer or processor. A data structure can be stored in the storage medium executable by the computer or processor. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as a computer-readable instruction code, a data structure, a program module or other data. The communication medium typically includes the computer-readable instruction code, the data structure, the program module, or other data of a modulated data signal such as a carrier wave, or other transmission mechanism, and includes information transmission mediums.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A frame-based opinion spam determination method which is performed by a processor of a frame-based opinion spam determination device, comprising:
(a) receiving an input text; and
(b) determining whether or not the input text is opinion spam using a machine learning-based opinion spam determination model considering a frame extracted from multiple opinion spam samples as an opinion spam determination element, wherein the frame is a semantic unit included in an event expressed in a sentence.

2. The frame-based opinion spam determination method of claim 1, further comprising:
(p) extracting the frame from each sentence included in the multiple opinion spam samples prior to (a); and
(q) constructing the opinion spam determination model by inserting the frame into a machine learning-based classification model as an opinion spam determination element.

3. The frame-based opinion spam determination method of claim 2, wherein (p) includes:
(p-1) dividing each of the opinion spam samples into at least one sentence; and
(p-2) extracting the frame from the divided sentence with reference to a frame dictionary database in which relationships between frames and words are defined according to a context.

4. The frame-based opinion spam determination method of claim 3, wherein (p-1) further includes:
analyzing a relationship between words included in each of the divided sentences, and (p-2) further includes:
finding a main word that triggers a specific frame from the analyzed sentence with reference to the frame dictionary database, finding a context around the main word, and extracting a frame of the analyzed sentence with reference to the main word and the context.

5. The frame-based opinion spam determination method of claim 1, wherein the opinion spam sample is a negative or positive opinion about a specific object.

6. The frame-based opinion spam determination method of claim 2, further comprising:
(r) after (p), quantifying a frequency of the extracted frame within the multiple opinion spam samples and selecting a certain number of frames in order of frequency.

7. The frame-based opinion spam determination method of claim 6,
wherein (p) further includes:
extracting a frame from each sentence included in multiple real opinions written by users using a specific object, and
(r) further includes:
quantifying a frequency of the extracted frame within the multiple real opinions, and selecting a certain number of the frames extracted from the real opinions and the frames extracted from the opinion spam samples depending on the frequencies of the frames within the real opinions and the opinion spam samples.

8. The frame-based opinion spam determination method of claim 6, wherein (r) includes:
quantifying a frequency of the extracted frame using at least one of indexes NFF (Normalized Frame Frequency) and NF_{BO}F (Normalized Frame Binary Ordering Frequency).

9. The frame-based opinion spam determination method of claim 6, wherein (q) includes:
inserting the frame selected in the (r) into the machine learning-based classification model as the opinion spam determination element.

10. A frame-based opinion spam determination device comprising:
a memory configured to store a program for determining whether or not an input text is opinion spam using a frame which is a semantic unit included in an event expressed in a sentence; and
a processor configured to execute the program,
wherein the process receives the input text and determines whether or not the input text is opinion spam considering a frame extracted from multiple opinion spam samples as an opinion spam determination element upon execution of the program.

11. The frame-based opinion spam determination device of claim 10, wherein the processor extracts the frame from each sentence included in the multiple opinion spam samples.

12. The frame-based opinion spam determination device of claim 11, wherein the processor divides each of the opinion spam samples into at least one sentence; and extracts the frame from the divided sentence with reference to a frame dictionary database in which relationships between frames and words are defined according to a context.

13. The frame-based opinion spam determination device of claim 12, wherein the processor analyzes a relationship between words included in each of the divided sentences, and finds a main word that triggers a specific frame from the analyzed sentence with reference to the frame dictionary database, finds a context around the main word, and extracts a frame of the analyzed sentence with reference to the main word and the context.

14. The frame-based opinion spam determination device of claim 10, wherein the opinion spam sample is a negative or positive opinion about a specific object.

15. The frame-based opinion spam determination device of claim 10, wherein after extracting the frame, the processor quantifies a frequency of the extracted frame within the multiple opinion spam samples and selects a certain number of frames in order of frequency.

16. The frame-based opinion spam determination device of claim 15, wherein the processor extracts a frame from each sentence included in multiple real opinions written by users using a specific object, quantifies a frequency of the extracted frame within the multiple real opinions, and selects a certain number of the frames extracted from the real opinions and the frames extracted from the opinion spam samples depending on the frequencies of the frames within the real opinions and the opinion spam samples.

17. The frame-based opinion spam determination device of claim 15, wherein the processor quantifies a frequency of the extracted frame using at least one of indexes NFF (Normalized Frame Frequency) and NF_{BO}F (Normalized Frame Binary Ordering Frequency).

18. The frame-based opinion spam determination device of claim 15, wherein the processor determines whether or not the input text is opinion spam considering the selected frames as opinion spam determination elements.

19. A computer readable recording medium which stores a computer program for executing a frame-based opinion spam determination method of any one of claim 1 to claim 9.
